(19) United States
(12) Patent Application Publication
(10) Pub. No.: US 2014/0278879 A1
(43) Pub. Date: Sep. 18, 2014

(54) METHOD AND SYSTEM FOR PREVENTION OF VIOLATIONS IN OFFER REDEMPTION

(71) Applicant: MASTERCARD INTERNATIONAL INCORPORATED, Purchase, NY (US)

(72) Inventors: Andrea Christine GILMAN, Chappaqua, NY (US); Christopher Andrew Guiney, Fenton, MO (US); Lisa Yates, Ballwin, MO (US)

(73) Assignee: MasterCard International Incorporated, Purchase, NY (US)

(21) Appl. No.: 13/795,015

(22) Filed: Mar. 12, 2013

(51) Int. Cl. G06Q 30/02

(52) U.S. Cl. CPC G06Q 30/0225
USPC 705/14.26

(57) ABSTRACT

A method for determining the validity of an offer redemption includes: storing, in an algorithm database, at least one scoring algorithm, each algorithm associated with an offer identification; storing, in a consumer database, consumer profiles, each profile including a consumer identification and evaluation data; receiving transaction information for a financial transaction, the transaction including a consumer identifier, an offer identifier, and a redeemed offer; identifying a specific profile, wherein the consumer identification corresponds to the consumer identifier; identifying a specific algorithm, wherein the offer identification corresponds to the offer identifier; identifying a redemption validity score based on the redeemed offer and an application of the specific algorithm to the evaluation data of the specific profile; and transmitting the identified redemption validity score to an entity associated with the offer identifier.

### FIELD

The present disclosure relates to the prevention of violations of offer terms and conditions in redemption of the offer, specifically, using scoring algorithms and consumer profiles to identify violations in the redemption of an offer by a consumer.

### BACKGROUND

In order to increase revenue and obtain returning consumers, many merchants and manufacturers issue coupons, deals, offers, discounts, etc. (“offers”) to consumers. These offers may allow for savings by the consumer, while at the same time resulting in additional revenue to merchants and manufacturers as a result of the purchase, and in some instances further revenue if the consumer becomes a repeat customer for the merchant or manufacturer by virtue of the offer. The success of many offer programs have resulted in an increase in the different types and varieties of offers distributed to consumers and also the creation of third party offer providers, which distribute offers to consumers on behalf of multiple other merchants or manufacturers.

However, as both the amount of offers and the frequency of offer redemptions have increased, the rate of improper offer redemptions that are in violation of the terms and conditions of the improperly redeemed offer have also increased. Such improper redemptions may result in a loss of revenue to the offer provider, and in instances where the offer provider may be a product manufacturer, may also have an adverse effect on the merchant through which the product is purchased with the improper offer. Common current systems that process offer redemptions often are not sufficiently equipped or configured to identify violations in the redemption of an offer until after the corresponding financial transaction has occurred.

Thus, there is a need for a technical solution to prevent the violation of offer terms and conditions in the redemption of offers.

### SUMMARY

The present disclosure provides a description of a technical solutions in the form of systems and methods for the distribution of offers and offer profiles based on redemption history and a system and method for the fulfillment of a request for offer profiles.

A method for determining the validity of an offer redemption includes: storing, in an algorithm database, at least one scoring algorithm, wherein each scoring algorithm is associated with at least one offer identification; storing, in a consumer database, a plurality of consumer profiles, wherein each consumer profile includes at least a consumer identification and evaluation data; receiving, by a receiving device, transaction information for a financial transaction, wherein the financial transaction includes at least a consumer identifier, an offer identifier, and a redeemed offer; identifying, in the consumer database, a specific consumer profile, wherein the consumer identification of the specific consumer profile corresponds to the consumer identifier of the received transaction information; identifying, in the algorithm database, a specific scoring algorithm, wherein the offer identification of the specific scoring algorithm corresponds to the offer identifier of the received transaction information; identifying, by a processing device, a redemption validity score based on at least the redeemed offer and an application of the specific scoring algorithm to the evaluation data of the specific consumer profile; and transmitting, by a transmitting device, the identified redemption validity score to an entity associated with the offer identifier of the received transaction information.

A method for processing a rebate request includes: storing, in an algorithm database, at least one scoring algorithm, wherein each scoring algorithm is associated with at least one offer identification; storing, in a consumer database, a plurality of consumer profiles, wherein each consumer profile includes at least a consumer identification, evaluation data, and an account identification; receiving, by a receiving device, a rebate request, wherein the rebate request includes at least a consumer identifier, an offer identifier, a rebate amount, and an offer; identifying, in the consumer database, a specific consumer profile, wherein the consumer identification of the specific consumer profile corresponds to the consumer identifier of the received transaction information; identifying, in the algorithm database, a specific scoring algorithm, wherein the offer identification of the specific scoring algorithm corresponds to the offer identifier of the received transaction information; identifying, by a processing device, a redemption validity score based on at least the offer and an application of the specific scoring algorithm to the evaluation data of the specific consumer profile; and processing a rebate for the rebate amount on a financial account associated with the account identification of the specific consumer profile if the redemption validity score does not exceed a predetermined validity threshold.

A system for determining the validity of an offer redemption includes an algorithm database, a consumer database, a receiving device, a processing device, and a transmitting device. The an algorithm database is configured to store at least one scoring algorithm, wherein each scoring algorithm is associated with at least one offer identification. The consumer database is configured to store a plurality of consumer profiles, wherein each consumer profile includes at least a consumer identification and evaluation data. The receiving device is configured to receive transaction information for a financial transaction, wherein the financial transaction includes at least a consumer identifier, an offer identifier, and a redeemed offer. The processing device is configured to: identify, in the consumer database, a specific consumer profile, wherein the consumer identification of the specific consumer profile corresponds to the consumer identifier of the received transaction information; identify, in the algorithm database, a specific scoring algorithm, wherein the offer identification of the specific scoring algorithm corresponds to the offer identifier of the received transaction information; and identify a redemption validity score based on at least the redeemed offer and an application of the specific scoring algorithm to the evaluation data of the specific consumer profile. The transmitting device is configured to transmit the identified redemption validity score to an entity associated with the offer identifier of the received transaction information.

A system for processing a rebate request includes an algorithm database, a consumer database, a receiving device, and a processing device. The algorithm database is configured to store at least one scoring algorithm, wherein each scoring algorithm is associated with at least one offer identification. The consumer database is configured to store a plurality of consumer profiles, wherein each consumer profile includes at least a consumer identification, evaluation data, and an account identification. The receiving device is configured to receive a rebate request, wherein the rebate request includes at least a consumer identifier, an offer identifier, a rebate amount, and an offer. The processing device is configured to: identify, in the consumer database, a specific consumer profile, wherein the consumer identification of the specific consumer profile corresponds to the consumer identifier of the received transaction information; identify, in the algorithm database, a specific scoring algorithm, wherein the offer identification of the specific scoring algorithm corresponds to the offer identifier of the received transaction information; identify a redemption validity score based on at least the offer and an application of the specific scoring algorithm to the evaluation data of the specific consumer profile; and process a rebate for the rebate amount on a financial account associated with the account identification of the specific consumer profile if the redemption validity score does not exceed a predetermined validity threshold

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the prevention of violations in offer redemption in accordance with exemplary embodiments.

FIG. 2 is a diagram illustrating a processing server for use in the system of FIG. 1 in accordance with exemplary embodiments.

FIG. 3 is a diagram illustrating a consumer database of the processing server of FIG. 2 in accordance with exemplary embodiments.

FIG. 4 is a flow diagram illustrating a method for identifying a redemption validity score for an offer redemption in accordance with exemplary embodiments.

FIG. 5 is a flow diagram illustrating a method for processing a rebate of an offer in accordance with exemplary embodiments.

FIG. 6 is a flow chart illustrating an exemplary method for determining the validity of an offer redemption in accordance with exemplary embodiments.

FIG. 7 is a flow chart illustrating an exemplary method for processing a rebate request in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the invention recited in the claims appended hereto.

### DETAILED DESCRIPTION

### Definition of Terms

Offer—A discount available to a consumer for the purchase, exchange, etc. for goods, services, products, etc. As used herein, offer may be considered synonymous with discount, deal, coupon, or any other term used to indicate that a discount is available to a consumer. An offer may be issued by a merchant, retailer, manufacturer, offer or deal provider, payment card issuer, or any other entity that may issue or be authorized to issue offers to consumers. An offer may be a physical offer or coupon (e.g., in a printed form that may be carried by the consumer) or a virtual offer or coupon, which may be stored in an electronic device (e.g., a server database, a smart phone) and applied to a transaction (e.g., via presentation to a merchant, automatic application to the transaction by association with a payment account of the consumer, automatic application to the transaction by the merchant, etc.).

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard® and VISA®.

### System for Preventing Violation of Offer Terms in Offer Redemption

FIG. 1 is a high level architecture illustrating a system 100 for the prevention of offer terms and conditions in the redemption of the offer.

The system 100 may include a consumer 102. The consumer 102 may receive an offer from an offer provider 104, such as an offer for the purchase of goods or services (e.g., products). The offer may include terms and conditions that must be accepted by the consumer 102 in order to redeem the offer. Terms and conditions may include limitations on redemption of the offer, such as a required minimum transaction amount, a start date or expiration date, a product requirement (e.g., must buy three or more), a joint offer restriction (e.g., not valid with any other offer), a frequency limit (e.g., may not redeem more than once a week), a total redemption quantity, etc. The terms and conditions may be such that, if a term or condition is violated, the consumer 102 should be unable to redeem the offer, or other adverse consequence.

The consumer 102 may visit the merchant 106 (e.g., physically, such as at a brick-and-mortar location, or remotely, such as via the Internet). The consumer 102 may engage in a financial transaction with the merchant 106 and present the offer to the merchant 106 for use in the transaction. In some instances, the merchant 106 may submit an authorization request for the financial transaction including the offer to a payment network for processing. In other instances, the merchant 106 may first submit the offer for redemption to the offer provider 104, who may then forward the relevant information to a processing server 108, or the merchant 106 may submit the offer information directly to the processing server 108.

The processing server 108, discussed in more detail below, may be configured to determine the validity of the redemption of the offer. The processing server 108 may identify the consumer 102 in a consumer database 112, discussed in more detail below, and may identify an algorithm in an algorithm database 110 corresponding to the offer or the offer provider 104. It should be noted that the algorythm may be specific to a particular offer, or may be generally applicable to a plurality of offers of the same or different types. The processing server 108 may identify a redemption validity score for the attempted offer redemption based on at least the redeemed offer, the consumer 102, and the identified algorithm.

In some embodiments, the processing server 108 may provide the redemption validity score to the offer provider 104 or the merchant 106, to determine if the offer should be redeemed based on the score. In other embodiments, the processing server 108 may make a determination as to the redemption of the offer based on the score, and notify the merchant 106 and/or the offer provider 104 of the approval or denial of the redemption. The merchant 106 may receive the notification of the approval or denial of the redemption and process the financial transaction accordingly. In instances where the offer information may be submitted via an authorization request, the approval or denial of the offer may be indicated in the authorization response received by the merchant 106.

The merchant 106 and/or the offer provider 104 may notify the consumer 102 of the approval or denial of the offer redemption. The processing server 108 may also store data relating to the offer redemption in the consumer database 112, such as in a consumer data entry storing data related to the consumer 102, discussed in more detail below. Such storage of data relating to attempted offer redemptions by the consumer 102 may enable the processing server 108 to provide more accurate, real-time scoring of future offer redemptions attempted by the consumer 102, which may assist in identifying patterns of violations by a consumer 102 and subsequently denying the redemption of offers in violation of the terms and conditions by the consumer 102.

Communications between each of the entities of the systems 100 may be made via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

### Processing Server

FIG. 2 illustrates an embodiment of the processing server 108 for use in the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include the algorithm database, the consumer database 112, a receiving unit 202, a processing unit 204, and a transmitting unit 206. Each of the components may be configured to communicate via a bus 208. Suitable types and configurations of the bus 208 will be apparent to persons having skill in the relevant art. Data stored in the algorithm database 110 and the consumer database 112 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 114).

The algorithm database 110 may be configured to store a plurality of scoring algorithms. Each scoring algorithm may be associated with at least one offer or offer provider 104. The scoring algorithms may be used to calculate a redemption validity score for the associated offer based on a variety of factors that, as will be apparent to persons having skill in the relevant art, may depend on the offer and its application, such as the consumer 102, the merchant 106, the type of offer, the value of the offer, the transaction for which the offer is to be applied, etc. The scoring algorithms themselves may also be different based on the individual application and offer, such as due to the terms and conditions of the offer, the value of the offer, etc. Suitable algorithms for scoring an offer redemption for validity with terms and conditions will be apparent to persons having skill in the relevant art.

The consumer database 112 may be configured to store consumer data entries including data related to consumers (e.g., the consumer 102). Data included in the consumer data entries, discussed in more detail below with respect to FIG. 3, may include identifying information and evaluation data associated with the consumer 102 for use in determining the validity of an attempted offer redemption by the consumer 102.

The receiving unit 202 may be configured to receive information from the offer provider 104 indicating scoring algorithms to be associated with offers distributed to consumers. In some instances, the receiving unit 202 may receive a scoring algorithm from the offer provider 104, and the processing unit 204 may store the scoring algorithm in the algorithm database 110. In other instances, scoring algorithms may be identified and stored by the processing server 108 itself (e.g., such as by a user inputting the algorithms into the processing server 108 via an input unit). The processing unit 204 may also store, in the algorithm database 110, associations of scoring algorithms with offers as identified by the offer provider 104, such as by associating a scoring algorithm with an offer identifier associated with an offer. An offer identifier may be any value used to identify an offer, such as a universal product code (UPC), serial number, manufacturer part number (MPN), European article number (EAN), etc.

The receiving unit 202 may be further configured to receive transaction information for a financial transaction, the transaction information including at least a consumer identifier, an offer identifier, and a redeemed offer, but typically would include additional information. The processing unit 204 may identify a consumer data entry in the consumer database 112 using the received consumer identifier, discussed in more detail below. The processing unit 204 may also identify a scoring algorithm stored in the algorithm database 110, perhaps based on the received offer identifier. The redeemed offer may include any offer information or details for use in the identified scoring algorithm. In some embodiments, the transaction information may also include information related to the financial transaction itself as necessary for use in the identified scoring algorithm, such as a transaction amount.

The processing unit 204 may, based on at least the identified consumer data entry and offer, identify a redemption validity score using the identified scoring algorithm. The redemption validity score may be a score indicating the likelihood that the attempted offer redemption is in violation of the terms and conditions of the offer. For example, an offer redemption may receive a high score if the consumer 102 has previously redeemed a similar offer in violation of the terms and conditions at the same merchant 106 in a transaction having a similar transaction amount, which may indicate that the present attempted offer redemption is likely in violation of the terms and conditions. This may allow for the offer provider 104 and/or the merchant 106 to deny redemption of the offer, which may prevent a loss in revenue to both the offer provider 104 and the merchant 106.

In some embodiments, the transmitting unit 206 may be configured to transmit the identified redemption validity score to the offer provider 104 or the merchant 106, for use in determining whether or not to approve redemption of the offer. In other embodiments, the processing unit 204 may be configured to identify if the offer redemption should be approved or denied, based on the redemption validity score and any other suitable information as will be apparent to persons having skill in the relevant art, such as consumer information associated with the consumer 102 and included in the consumer database 112. The transmitting unit 206 may be configured to transmit to the offer provider 104 and/or the merchant 106 a notification indicating the approval or denial of the offer redemption.

In one embodiment, the receiving unit 202 may be configured to receive a request for a rebate in lieu of transaction information, such as when an offer is redeemed at the merchant 106 and a rebate is to be processed following the offer redemption. In such an embodiment, the processing unit 204 may identify a redemption validity score as discussed above, and may then process a rebate for a specified rebate amount on a financial account associated with the consumer 102 (e.g., included in a related consumer data entry in the consumer database 112) if the redemption validity score does not exceed a predetermined validity threshold. The predetermined validity threshold may be defined by the offer provider 104 or the processing server 108, and may represent a score that indicates that the redemption of the offer is likely to be in violation of the terms and conditions of the offer.

### Consumer Database

FIG. 3 is an illustration of the consumer database 112 of the processing server 108 for use in the system 100. The consumer database 112 may include a plurality of consumer data entries 302 that may include data related to consumers (e.g., the consumer 102), illustrated in FIG. 3 as consumer data entries 302a, 302b, and 302c. Each consumer data entry 302 may include at least a consumer identification 304, a violation score 306, and evaluation data 308.

The consumer identification 304 may be a unique value used to identify the consumer data entry 302 as related to a specific consumer (e.g., the consumer 102) and to identify the consumer data entry 302 apart from other consumer data entries. Suitable values for use as the consumer identification 304 will be apparent to persons having skill in the relevant art and may include one or more of: an identification number, a serial number, a telephone number, an e-mail address, a username, a registration number, a financial account number, etc. In some instances, the consumer identification 304 may be an account number associated with a financial account accessible by the related consumer 102, which may be used in the processing of rebates resulting in the redemption of offers by the consumer 102.

The violation score 306 may be a score associated with the consumer 102 that may indicate the propensity for the consumer 102 to attempt to redeem an offer in violation of the offer's terms and conditions. The violation score 306 may be based on an offer redemption history 312 of the consumer that may be included as part of the evaluation data 308. The violation score 306 may also be based on additional information as will be apparent to persons having skill in the relevant art.

The evaluation data 308 may include at least transaction data 310 and the offer redemption history 312. The evaluation data 308 may be data used by the processing server 108 to identify the redemption validity score for an attempted offer redemption. The transaction data 310 may include data related to a plurality of financial transactions involving the consumer 102. In an exemplary embodiment, the transaction data 310 may be grouped (e.g., bucketed) to protect the privacy of the consumer 102 or may be acquired with the expressed consent of the consumer 102. The offer redemption history 312 may be a history of the redemption of offers by the consumer 102, and may indicate the details of an offer, the transaction for which redemption of the offer is attempted, and the results of the attempted redemption (e.g., approved, denied by the processing server 108, denied by a third party, identified redemption validity score, etc.). In some embodiments the evaluation data 308 may further include credit information, a risk profile, redemption frequency, ongoing rebate currency amount, rebate merchant location, and enrollment modification history.

In some embodiments, the processing unit 204 of the processing server 108 may be configured to update the violation score 306 included in the consumer data entry 102 associated with the consumer 102 following each financial transaction involving the consumer 102 where the consumer 102 attempts to redeem an offer. In other embodiments, the processing unit 204 may identify an updated violation score 306 for the consumer 102 at a predetermined time or predetermined intervals, and may update the violation score 306 based on the evaluation data 308.

### Processing Server Flow Diagram for Identifying a Redemption Validity Score

FIG. 4 illustrates a flow diagram for a method for identifying a redemption validity score via the processing server 108 of the system 100.

In step 402, the receiving unit 202 of the processing server 108 may receive transaction information. In some embodiments, the processing server 108 may be a part of a payment network and may receive the transaction information as part of an authorization request for a financial transaction. In an exemplary embodiment, the transaction information may include at least a consumer identifier, an offer identifier, and the offer to be redeemed.

In step 404, the processing unit 204 may identify if there is a consumer data entry 302 related to the consumer 102 in the consumer database 112 based on the consumer identifier included in the transaction information, such as by identifying a consumer data entry 302 including a consumer identification 304 corresponding to the consumer identifier. If a consumer data entry 302 exists corresponding to the consumer identifier, then, in step 406, the processing unit 204 may identify that consumer data entry 302. If no such consumer data entry exists, then, in step 408, the processing server 108 may retrieve consumer data (e.g., from the consumer 102, the offer provider 104, based on the consumer identifier, etc.). In step 410, the processing unit 204 may build a consumer profile for the consumer 102 by creating a new consumer data entry 302 in the consumer database 112 related to the consumer 102 and include data retrieved in step 408.

In step 412, the processing unit 204 may identify if the offer to be redeemed is associated with an algorithm in the algorithm database 110, such as by identifying if any algorithm in the algorithm database 110 is associated with the offer identifier received in the transaction information. If the offer is associated with an algorithm, then, in step 414, the processing unit 204 may identify the scoring algorithm to be used.

If the offer is not associated with an algorithm, then, in step 416, the processing unit 204 may identify a suitable algorithm to use to score the validity of the redemption. Methods for identifying a suitable algorithm will be apparent to persons having skill in the relevant art and may include identifying a default algorithm specified by the originator of the offer, identifying algorithms associated with similar offers, identifying algorithms with higher success rates for similar offers, etc. In step 418, the processing unit 204 may associate the identified suitable algorithm with the offer for use in future redemption validity determinations.

In step 420, the processing unit 204 may identify a redemption validity score for the attempted offer redemption based on at least the redeemed offer and an application of the identified algorithm to the evaluation data 308 included in the identified consumer data entry 302. In step 422, the transmitting unit 206 may transmit the redemption validity score to the originator of the offer, such as the offer provider 104 or the merchant 106. In such an embodiment where the processing server 108 may be part of a payment network, the processing server 108 or another processor in the payment network may further determine if redemption of the offer is to be approved or denied and may subsequently process the financial transaction and transmit an authorization response to the merchant 106.

### Processing Server Flow Diagram for Processing a Rebate

FIG. 5 illustrates a flow diagram for a processing a rebate via the processing server 108 of the system 100.

In step 502, the receiving unit 202 of the processing server 108 may receive a rebate request. In an exemplary embodiment, the rebate request may include at least a consumer identifier, an offer identifier, a rebate amount, and an offer. The rebate amount may be an amount that is to be rebated to a consumer (e.g., the consumer 102) associated with the consumer identifier if the redemption of the offer is found to be valid. In step 504, the processing unit 204 may identify, in the consumer database 112, the consumer profile 302 related to the consumer 102 where the consumer identification 304 corresponds to the consumer identifier.

In step 506, the processing unit 204 may identify a scoring algorithm in the algorithm database 110, as discussed above, that is associated with the offer based on the received offer identifier. Then, in step 508, the processing unit 204 may use the identified scoring algorithm and evaluation data 308 included in the identified consumer profile 302 to determine a redemption validity score. In step 510, the processing unit 204 may determine if the redemption validity score exceeds a validity threshold. The validity threshold may be defined by the offer provider 104, the processing server 108, may be associated with the specific offer, may be associated with the identified scoring algorithm, etc.

If the validity threshold is not exceeded by the redemption validity score, it may indicate that the offer is being redeemed within the offer terms and conditions and, in step 512, the processing unit 204 may process the rebate. Processing the rebate may include, for example, processing a payment to a financial account associated with the consumer 102 for the rebate amount specified in the rebate request (e.g., from the offer provider 104, the merchant 106, or a third party). In some embodiments, information identifying the financial account may be included in the consumer profile 302 related to the consumer 102 in the consumer database 112. In a further embodiment, the financial account number may be the consumer identifier 304.

If the threshold is exceeded by the redemption validity score, it may indicate that the terms and conditions of the offer are being violated or were violated in the redemption of the offer by the consumer 102. If the threshold is exceeded, then, in step 514, the processing unit 204 may reject the rebate and withhold processing of the rebate request. In step 516, the transmitting unit 206 may transmit a notification to the originator of the offer (e.g., the offer provider 104, the merchant 106, a deal aggregator, etc.) indicating that the rebate is rejected due to a high redemption validity score.

In step 518, the processing unit 204 may update the consumer profile 302 related to the consumer 102 following the processing or rejection of the rebate. The updating of the consumer profile 302 may include updating the violation score 306 included in the consumer profile 302 and/or updating the evaluation data 308 to reflect the approval or denial of the rebate. For example, the offer redemption history 312 of the evaluation data may be updated to include the offer redemption and subsequent denying or approving of the rebate request by the processing unit 204.

### Exemplary Method for Determining the Validity of an Offer Redemption

FIG. 6 illustrates a method 600 for determining the validity of an offer redemption.

In step 602, at least one scoring algorithm may be stored in an algorithm database (e.g., the algorithm database 110), wherein each scoring algorithm is associated with at least one offer identification. In step 604, a plurality of consumer profiles (e.g., consumer data entries 302) may be stored in a consumer database (e.g., the consumer database 112), wherein each consumer profile 302 includes at least a consumer identification (e.g., the consumer identification 304) and evaluation data (e.g., the evaluation data 308). In one embodiment, the evaluation data 308 may include at least one of: offer redemption history (e.g., the offer redemption history 312), transaction data (e.g., the transaction data 310), credit information, a risk profile, redemption frequency, ongoing rebate currency amount, rebate merchant location, and enrollment modification history.

In step 606, a receiving device (e.g., the receiving unit 202) may receive transaction information for a financial transaction, wherein the financial transaction includes at least a consumer identifier, an originator identifier, and a redeemed offer. In step 608, a specific consumer profile 302 may be identified in the consumer database 112, wherein the consumer identification 304 of the specific consumer profile 302 corresponds to the consumer identifier of the received transaction information. In step 610, a specific scoring algorithm may be identified in the algorithm database 110, wherein the offer identification of the specific scoring algorithm corresponds to the offer identifier of the received transaction information.

In step 612, a redemption validity score may be identified by a processing device (e.g., the processing unit 204) based on at least the redeemed offer and an application of the specific scoring algorithm to the evaluation data 308 of the specific consumer profile 302. In one embodiment, the redemption validity score may indicate the likelihood that redemption of the redeemed offer included in the transaction information is improper. In some embodiments, each consumer profile may further include a violation score (e.g., the violation score 306), and the redemption validity score may be further based on the violation score 306 of the specific consumer profile 302.

In step 614, a transmitting device (e.g., the transmitting unit 206) may transmit the identified redemption validity score to an entity (e.g., the offer provider 104) associated with the offer identifier of the received transaction information. In one embodiment, the entity associated with the offer identifier may be a deal aggregator. In embodiments where each consumer profile 302 may include a violation score 306, the method 600 may further include updating, in the specific consumer profile 302, the violations core 306 based on the identified redemption validity score. In a further embodiment, the transmitting device 206 may transmit the updated violation score 306 to the entity associated with the offer identifier.

In one embodiment, the method 600 may further include: identifying, by the processing device 204, a redemption recommendation, and transmitting, by the transmitting device 206, the redemption recommendation to the entity associated with the offer identifier. The redemption recommendation may be based on at least the identified redemption validity score, and the redemption recommendation may indicate if the redeemed offer included in the transaction information is improper.

### Exemplary Method for Processing a Rebate Request

FIG. 7 illustrates a method 700 for the processing of a rebate request.

In step 702, at least one scoring algorithm may be stored in an algorithm database (e.g., the algorithm database 110), wherein each scoring algorithm is associated with at least one offer identification. In step 704, a plurality of consumer profiles (e.g., consumer data entries 302) may be stored in a consumer database (e.g., the consumer database 112), wherein each consumer profile 302 includes at least a consumer identification (e.g., the consumer identification 304), evaluation data (e.g., the evaluation data 308), and an account identification. In one embodiment, the consumer identification 304 may be the account identification. In some embodiments, the evaluation data 308 may include at least one of: offer redemption history (e.g., the offer redemption history 312), transaction data (e.g., the transaction data 310), credit information, a risk profile, redemption frequency, ongoing rebate currency amount, rebate merchant location, and enrollment modification history.

In step 706, a rebate request may be received by a receiving device (e.g., the receiving unit 202), wherein the rebate request includes at least a consumer identifier, an offer identifier, a rebate amount, and an offer. In one embodiment, the offer identifier may be associated with a deal aggregator (e.g., the offer provider 104). In step 708, a specific consumer profile 302 may be identified in the consumer database 112, wherein the consumer identification 304 of the specific consumer profile 302 corresponds to the consumer identifier of the received transaction information. In step 710, a specific scoring algorithm may be identified in the algorithm database 110, wherein the offer identification of the specific scoring algorithm corresponds to the offer identifier of the received transaction information.

In step 712, a redemption validity score may be identified by a processing device (e.g., the processing unit 204) based on at least the offer and an application of the specific scoring algorithm to the evaluation data 308 of the specific consumer profile 302. In one embodiment, the redemption validity score may indicate the likelihood that redemption of the offer included in the rebate request is improper. In some embodiments, each consumer profile 302 may further include a violation score (e.g., the violation score 306), and the identified redemption validity score may be further based on the violation score 306 of the specific consumer profile 302.

In step 714, a rebate may be processed (e.g., by the processing device 204) for the rebate amount on a financial account associated with the account identification of the specific consumer profile 302 if the redemption validity score does not exceed a predetermined validity threshold. In one embodiment, the predetermined validity threshold may be associated with the offer. In another embodiment, the predetermined validity threshold may be associated with the specific scoring algorithm. In embodiments where the specific consumer profile 302 may include a violation score 306, the method 700 may further include updating, in the specific consumer profile 302, the violation score 306 based on the identified redemption validity score. In a further embodiment, step 714 may include processing the rebate also if the updated violation score 306 does not exceed a predetermined violation score threshold.

### Computer System Architecture

FIG. 8 illustrates a computer system 800 in which embodiments of the present disclosure, or portions thereof, may be implemented as computer-readable code. For example, the offer provider 104, the merchant 106, and the processing server 108 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 114), multi-core message-passing scheme, etc. The computer system 800 may also include a main memory 808 (e.g., random access memory, read-only memory, etc.), and may also include a secondary memory 88. The secondary memory 88 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 88 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 88, which may be memory semiconductors (e.g. DRAMs, etc.). These computer program products may be means for providing software to the computer system 800. Computer programs (e.g., computer control logic) may be stored in the main memory 808 and/or the secondary memory 88. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for the determination of the validity of an offer redemption and the processing of rebate requests. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining validity of an offer redemption, comprising:
storing, in an algorithm database, at least one scoring algorithm, wherein each scoring algorithm is associated with at least one offer identification;
storing, in a consumer database, a plurality of consumer profiles, wherein each consumer profile includes at least a consumer identification and evaluation data;
receiving, by a receiving device, transaction information for a financial transaction, wherein the financial transaction includes at least a consumer identifier, an offer identifier, and a redeemed offer;
identifying, in the consumer database, a specific consumer profile, wherein the consumer identification of the specific consumer profile corresponds to the consumer identifier of the received transaction information;
identifying, in the algorithm database, a specific scoring algorithm, wherein the offer identification of the specific scoring algorithm corresponds to the offer identifier of the received transaction information;
identifying, by a processing device, a redemption validity score based on at least the redeemed offer and an application of the specific scoring algorithm to the evaluation data of the specific consumer profile; and
transmitting, by a transmitting device, the identified redemption validity score to an entity associated with the offer identifier of the received transaction information.

2. The method of claim 1, wherein the evaluation data includes at least one of: offer redemption history, transaction data, credit information, a risk profile, redemption frequency, ongoing rebate currency amount, rebate merchant location, and enrollment modification history.

3. The method of claim 1, wherein the entity associated with the offer identifier is a deal aggregator.

4. The method of claim 1, wherein each consumer profile further includes a violation score, and wherein the identified redemption validity score is further based on the violation score of the specific consumer profile.

5. The method of claim 4, further comprising:
updating, in the specific consumer profile, the violation score based on the identified redemption validity score.

6. The method of claim 5, further comprising:
transmitting, by the transmitting device, the updated violation score to the entity associated with the offer identifier.

7. The method of claim 1, further comprising:
identifying, by the processing device, a redemption recommendation, and
transmitting, by the transmitting device, the redemption recommendation to the entity associated with the offer identifier, wherein
the redemption recommendation is based on at least the identified redemption validity score, and
the redemption recommendation indicates if the redeemed offer included in the transaction information is improper.

8. The method of claim 1, wherein the redemption validity score indicates the likelihood that redemption of the redeemed offer included in the transaction information is improper.

9. A method for processing a rebate request, comprising:
storing, in an algorithm database, at least one scoring algorithm, wherein each scoring algorithm is associated with at least one offer identification;
storing, in a consumer database, a plurality of consumer profiles, wherein each consumer profile includes at least a consumer identification, evaluation data, and an account identification;
receiving, by a receiving device, a rebate request, wherein the rebate request includes at least a consumer identifier, an offer identifier, a rebate amount, and an offer;
identifying, in the consumer database, a specific consumer profile, wherein the consumer identification of the specific consumer profile corresponds to the consumer identifier of the received transaction information;
identifying, in the algorithm database, a specific scoring algorithm, wherein the offer identification of the specific scoring algorithm corresponds to the offer identifier of the received transaction information;
identifying, by a processing device, a redemption validity score based on at least the offer and an application of the specific scoring algorithm to the evaluation data 308 of the specific consumer profile; and
processing a rebate for the rebate amount on a financial account associated with the account identification of the specific consumer profile if the redemption validity score does not exceed a predetermined validity threshold.

10. The method of claim 9, wherein the evaluation data includes at least one of: offer redemption history, transaction data, credit information, a risk profile, redemption frequency, ongoing rebate currency amount, rebate merchant location, and enrollment modification history.

11. The method of claim 9, wherein the offer identifier is associated with a deal aggregator.

12. The method of claim 9, wherein each consumer profile further includes a violation score, and wherein the identified redemption validity score is further based on the violation score of the specific consumer profile.

13. The method of claim 12, further comprising:
updating, in the specific consumer profile, the violation score based on the identified redemption validity score.

14. The method of claim 13, wherein processing the rebate further includes processing the rebate if the updated violation score does not exceed a predetermined violation score threshold.

15. The method of claim 9, wherein the redemption validity score indicates the likelihood that redemption of the offer included in the rebate request is improper.

16. A system for determining validity of an offer redemption, comprising:
an algorithm database configured to store at least one scoring algorithm, wherein each scoring algorithm is associated with at least one offer identification;
a consumer database configured to store a plurality of consumer profiles, wherein each consumer profile includes at least a consumer identification and evaluation data;
a receiving device configured to receive transaction information for a financial transaction, wherein the financial transaction includes at least a consumer identifier, an offer identifier, and a redeemed offer;
a processing device configured to
identify, in the consumer database, a specific consumer profile, wherein the consumer identification of the specific consumer profile corresponds to the consumer identifier of the received transaction information,
identify, in the algorithm database, a specific scoring algorithm, wherein the offer identification of the specific scoring algorithm corresponds to the offer identifier of the received transaction information, and
identify a redemption validity score based on at least the redeemed offer and an application of the specific scoring algorithm to the evaluation data of the specific consumer profile; and
a transmitting device configured to transmit, to an entity associated with the offer identifier of the received transaction information, the identified redemption validity score.

17. The system of claim 16, wherein the evaluation data includes at least one of: offer redemption history, transaction data, credit information, a risk profile, redemption frequency, ongoing rebate currency amount, rebate merchant location, and enrollment modification history.

18. The system of claim 16, wherein the entity associated with the offer identifier is a deal aggregator.

19. The system of claim 16, wherein each consumer profile further includes a violation score, and wherein the identified redemption validity score is further based on the violation score of the specific consumer profile.

20. The system of claim 19, wherein the processing device is further configured to update, in the specific consumer profile, the violation score based on the identified redemption validity score.

21. The system of claim 20, wherein the transmitting device is further configured to transmit, to the entity associated with the offer identifier, the updated violation score.

22. The system of claim 16, wherein
the processing device is further configured to identify a redemption recommendation,
the transmitting device is further configured to transmit, to the entity associated with the offer identifier, the redemption recommendation,
the redemption recommendation is based on at least the identified redemption validity score, and
the redemption recommendation indicates if the redeemed offer included in the transaction information is improper.

23. The system of claim 16, wherein the redemption validity score indicates the likelihood that redemption of the redeemed offer included in the transaction information is improper.

24. A system for processing a rebate request, comprising:
an algorithm database configured to store at least one scoring algorithm, wherein each scoring algorithm is associated with at least one offer identification;
a consumer database configured to store a plurality of consumer profiles, wherein each consumer profile includes at least a consumer identification, evaluation data, and an account identification;
a receiving device configured to receive a rebate request, wherein the rebate request includes at least a consumer identifier, an offer identifier, a rebate amount, and an offer; and
a processing device configured to
identify, in the consumer database, a specific consumer profile, wherein the consumer identification of the specific consumer profile corresponds to the consumer identifier of the received transaction information,
identify, in the algorithm database, a specific scoring algorithm, wherein the offer identification of the specific scoring algorithm corresponds to the offer identifier of the received transaction information,
identify a redemption validity score based on at least the offer and an application of the specific scoring algorithm to the evaluation data of the specific consumer profile, and
process a rebate for the rebate amount on a financial account associated with the account identification of the specific consumer profile if the redemption validity score does not exceed a predetermined validity threshold.

25. The system of claim 24, wherein the evaluation data includes at least one of: offer redemption history, transaction data, credit information, a risk profile, redemption frequency, ongoing rebate currency amount, rebate merchant location, and enrollment modification history.

26. The system of claim 24, wherein the offer identifier is associated with a deal aggregator.

27. The system of claim 24, wherein each consumer profile further includes a violation score, and wherein the identified redemption validity score is further based on the violation score of the specific consumer profile

28. The system of claim 27, wherein the processing device is further configured to update, in the specific consumer profile, the violation score based on the identified redemption validity score.

29. The system of claim 28, wherein processing the rebate further includes processing the rebate if the updated violation score does not exceed a predetermined violation score threshold.

30. The system of claim 24, wherein the redemption validity score indicates the likelihood that redemption of the offer included in the rebate request is improper.
